(19) United States
(12) Patent Application Publication
(10) Pub. No.: US 2004/0156076 A1
(43) Pub. Date: Aug. 12, 2004

(54) Method of and apparatus for image processing, and computer product

(76) Inventors: Atsushi Togami, Kanagawa (JP); Isao Miyamoto, Kanagawa (JP); Satoshi Ohkawa, Tokyo (JP); Yasunobu Shirata, Tokyo (JP); Maki Ohyama, Tokyo (JP); Hiroyuki Kawamoto, Kanagawa (JP); Taira Nishita, Kanagawa (JP); Tomoyuki Yoshida, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/663,804

(22) Filed: Sep. 17, 2003

(30) Foreign Application Priority Data
Sep. 17, 2002 (JP) 2002-269604
Sep. 24, 2002 (JP) 2002-276439
Nov. 6, 2002 (JP) 2002-322019

(51) Int. Cl. H04N 1/52; H04N 1/60; H04N 1/41; H04N 1/393

(52) U.S. Cl. 358/2.1; 358/519; 358/518; 358/534; 382/232; 358/1.2

(57) ABSTRACT

An image processing apparatus that processes image data and transmits processed image data to an external unit includes a content determination unit that determines content of image processing to be applied to image data for each image data, an image processing unit that applies the image processing of the content determined by the content determination unit to the image data, and a transmission unit that transmits the image data processed by the image processing unit to an external unit.

### BACKGROUND OF THE INVENTION

1) Field of the Invention

The present invention relates to a technology for image processing.

2) Description of the Related Art

One of the popular configuration for a full color image forming apparatus (hereinafter, “image forming apparatus”), such as a full color copying machine having a scanner unit (image input unit), and a full color scanner, includes a communication function (communication unit) for communicating with an information processing unit (terminal device) such as a personal computer and a work station on a network, and a distribution function (distribution unit) that is a network scanner distribution function for optically scanning an original document by a scanner unit to read the image (a full color image or a monochrome image), inputting image data of red, green, and blue (RGB) system, and distributing the image data to the image processing apparatus on the network.

For example, as described in Japanese Patent Application Laid Open Publication No. 2000-333026, an image editing system is proposed, which has an extension box based on an architecture of a general purpose computer system, so that image data read by optically scanning an original document by an image input unit (a scanner unit) of an image forming apparatus is stored in a hard disk drive (a scan box) in the extension box as an image file, and the image file in the scan box can be shared between respective computer systems (external devices) on the network.

In the image editing system, the image forming apparatus sets (selects) scan parameters (copy parameters) such as resolution, tone, magnification, reading face, image size, and where to store (memory), reads the image of an original document by the image input unit, and transfers the image data to an image processing unit, to execute image processing according to the scan parameters. At this time, the image data is converted to data of different format that can be processed by an output system.

In other words, image processing such as chromatic coordinate system conversion from the RGB system to CMYK (cyan, magenta, yellow, and black) system, tone correction, and the like is performed. The image data after the image processing is transferred to the extension box. In the extension box, the image data from the image forming apparatus is compressed, and temporarily accumulated (stored) in the scan box allocated in a predetermined area in the hard disk drive. After image data is stored for all documents (pages), clients on the network can fetch the image data from the scan box.

Further, it has been studied to use a method in which data stored in a special format convenient for outputting a copy in a copying machine is converted to a general purpose compressed format such as joint photographic experts group (JPEG), and this is distributed on the network as distribution data. According to this method, since the general format conversion unit can be used also at the destination, external apparatuses equipped with the general purpose conversion unit can use the data.

In such an image editing system, there are problems described below. The image data stored in the hard disk drive is often in a format that can be easily handled by the image forming apparatus (a format dedicated for the image forming apparatus), and may be compressed by a special algorithm at the time of compression for saving the memory. Therefore, even if the image data is distributed to an information processing unit such as a personal computer via the network, the image data cannot be read (the image cannot be browsed), edited, or processed by a general purpose application.

The original document read by the image input unit (image data input by the image input unit) may be a color document (full color data), or a monochrome document (monochrome data). When it is desired to change the condition setting with respect to the documents (image data), since it is necessary to perform the setting separately for each document, it is time-consuming.

In the process to convert the special format within the copying machine into the general format, another problem such as image deterioration occurs. This relates to background removal processing. The image data input by the scanner and stored in the hard disk drive (HDD) may be subjected to background removal processing (processing for detecting background components on the original document regarded as noise from the scanned image, and removing the background components from the scanned image data according to a result of the background detection) during processing with respect to the scanned image. However, there is no method for discriminating image data for which the background removal processing has been performed, which is then converted to the special format, and stored in the HDD.

Therefore, even if a unit that converts data into appropriate data in the process of format conversion with respect the distributed image is prepared, appropriate distributed image processing may not be performed, and hence background (noise) to be removed may be left, or an image that should not be removed may be removed, thereby causing image deterioration.

### SUMMARY OF THE INVENTION

It is an object of the present invention to solve at least the problems in the conventional technology.

The image processing apparatus according to one aspect of the present invention includes a content determination unit that determines content of image processing to be applied to each of a plurality of image data, an image processing unit that applies the image processing based on the content determined to corresponding image data, and a transmission unit that transmits the image data processed to an external unit.

The method for image processing according to another aspect of the present invention includes determining content of image processing to be applied to each of a plurality of image data, applying the image processing based on the content determined to corresponding image data, and transmitting the image data processed to an external unit.

The computer product according to still another aspect of the present invention realizes the methods according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWING

FIG. 1 is a schematic diagram of a full color multifunction product;

FIG. 2 is a block diagram of functional configuration of a color determination unit 41;

FIG. 3 is a timing chart indicating an effective image area signal START_X and a line synchronization signal LSYNC input to the color determination unit 41, at the time of image forming based on image data for one page;

FIG. 4 is a unit block (sixteen pixels) of four lines×four pixels;

FIG. 5 is a block diagram of functional configuration of a scanner correction unit 32;

FIG. 6 is a block diagram of functional configuration of a printer correction unit 37;

FIG. 7 is another schematic diagram of a full color multifunction product;

FIG. 8 is a block diagram of an image format conversion unit 10;

FIG. 9A and FIG. 9B illustrate a color conversion processing according to a seventh embodiment of the present invention;

FIG. 10A and FIG. 10B illustrate a format conversion processing according to the seventh embodiment; and

FIG. 11A and FIG. 11B illustrate a gradation processing according to the seventh embodiment.

### DETAILED DESCRIPTIONS

Exemplary embodiments of a method of and an apparatus for image processing and a computer program for image processing according to the present invention will be explained in detail, with reference to the accompanying drawings.

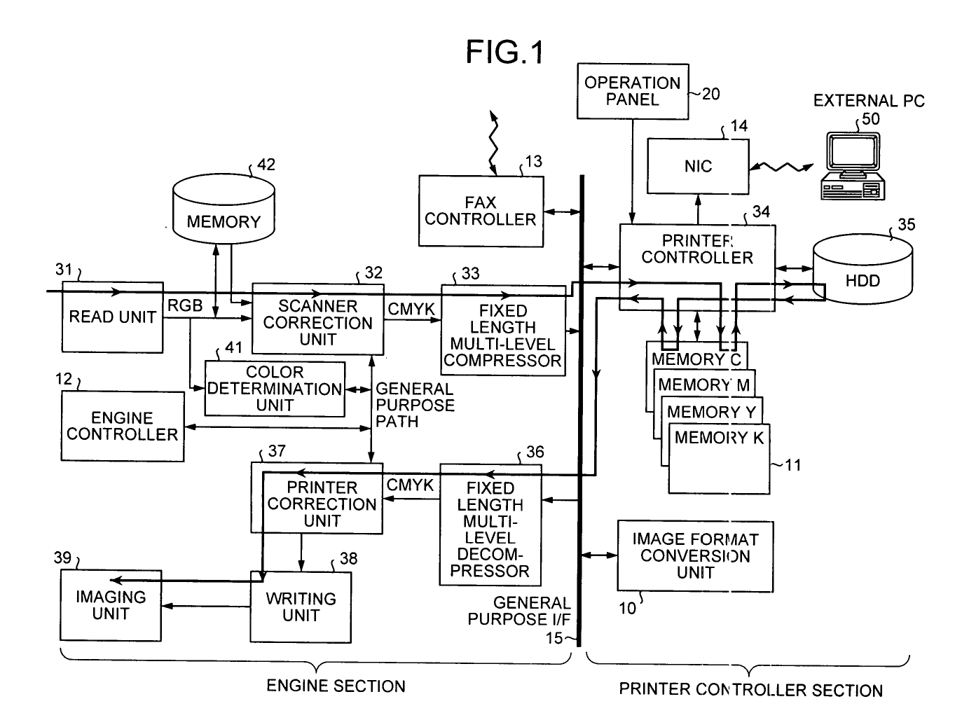

FIG. 1 is a block diagram illustrating a configuration example of a full color multifunction product (MFP) according to a first embodiment of the present invention, together with the flow of image data at the time of copying.

This full color multifunction product includes a plotter engine unit (hereinafter, “engine unit”), a printer controller unit, and an operation panel 20. The engine unit includes a read unit (a scanner unit) 1, a scanner correction unit 32, a memory 42, a fixed length multi-level compressor 3, an engine controller 12, a fixed length multi-level decompressor 36, a printer correction unit 37, a writing unit 38, an imaging unit 39, a facsimile controller 9, and the like.

The printer controller unit includes a printer controller 34, a semiconductor memory 11, an HDD 35, an image format conversion unit 10, a network interface controller (NIC) 14, and the like.

The image processing apparatus in the full color multifunction product is constituted of parts excluding parts corresponding to the printing unit (image forming unit) in the engine unit (for example, the WRITING UNIT 38 and the imaging unit 39).

The engine unit and the printer controller unit are connected with each other by a general purpose bus interface (I/F) 15.

The read unit 31 in the engine unit is an image input unit (image reader), and more specifically, the read unit 31 optically reads the image of an original document, which is set (placed) on a read position (for example, on a contact glass), or which is passing through the read position, by scanning the original document 1 by a document scanning unit using a charge-coupled device (CCD).

The read unit 31 then generates digital image data (eight bits) of color components composed of three colors of R, G, and B (R: RED, G: GREEN, B: BLUE). At this time, the read unit 31 photoelectrically transduces and amplifies the digital image data for each of color-separated lights of R (red), G (green), and B (blue), and sends the data to the scanner correction unit 32 as 8-bit image data (which may be other than eight bits) for each color of RGB, which is an electric image signal.

The original document to be read is set on the read position of the read unit 31 by a user, or original documents on an original table are set on the read position by automatically fed one by one by an auto document feeder (ADF), or the original document simply passes through the read position by the ADF. The image data read by the read unit 31 is assumed to be eight bits for each color, but the image data is not limited to eight bits.

The memory 42 stores the image data read by the read unit 31 temporarily. The memory 42 is used as a page buffer, and stores the image data received from the scanner unit 2. When the memory 42 receives the data for one page of the original documents, the memory 42 sends the stored data to the scanner correction unit 32. At this time, a result of determination whether the original document is a chromatic color document can be obtained.

Since the original document can be once stored in the page buffer, and the determination whether the original document is a chromatic color document can be performed before performing scanner correction, it is not necessary to perform the operation of pre-scanning and reading the document in the main scanning.

The scanner correction unit 32 performs filter processing, color correction (conversion) processing, reducing/enlarging, and the like with respect to the image data received from the read unit 31, to perform adjustment of sharpness, correction and conversion of hue, data conversion processing at the time of copying by enlarging or reducing the size, with respect to the image data.

The RGB image data is converted to image data composed of four color components of C, M, Y, and K (C: Cyan, M: Magenta, Y: Yellow, K: Black) by the color correction processing. The image data after processing is sent to the fixed length multi-level compressor (a fixed length lossy compressor) 33.

Concurrently with the image processing by the scanner correction unit 32, the color determination unit 41 performs color determination processing for determining whether the image data (original document) input from the read unit 31 is full color data (a full color document) or a monochrome data (a monochrome document), and notifies the engine controller 12 of the color determination result. The color determination result may be read by a central processing unit (CPU) in the engine controller 12 and used according to need.

The role of the color determination unit 41 in the copying operation will be explained. When it is necessary to set the operation mode under processing conditions suitable for each document, corresponding to the document type, color or monochrome, an operator (user) needs to perform appropriate setting and change the mode. But the color determination unit 41 can eliminate such a troublesome work.

The fixed length multi-level compressor 33 is a compression unit, which lossy compresses (encodes) the image data transmitted from the scanner correction unit 32. In other words, the fixed length multi-level compressor 33 converts the 8-bit color data (color signal) for each of the CMYK colors into 2-bit color data for each color (which may have bits other than two). Since the output unit of this fixed length multi-level compressor 33 is connected to the general purpose bus I/F 15, the CMYK image data after the lossy compression is transmitted to the printer controller 34 in the printer controller unit through the general purpose bus I/F 15.

For the printer controller 34, a microcomputer including a CPU, a read only memory (ROM), and a random access memory (RAM) is used, which comprehensively controls the whole printer controller unit. The printer function is operated when there is a printing request from an external personal computer (PC) 50 connected via the NIC 14. An existing unit can be used for the operation of the printer controller 4, and hence detailed explanation is omitted. The printer controller 4 generates a raster-image processed (RIP) image, which is used as drawing data in the engine unit, according to the print request received from the external PC 50.

The RIP image data is low bit data of about one to four bits for each of the CMYK colors, at the time of color printer operation, and at the time of monochrome printer operation, it is generated as 1-bit data only for K color.

At this time, the CMYK image and the K image subjected to the raster imager processing are stored in the HDD 35, but since the data size after the RIP is large, the data is compressed as at the time of using the copying function, and the compressed data is stored in the HDD 35. This compression processing is performed by a special purpose variable length lossless compressor provided respectively corresponding to the color and monochrome images in the printer controller 34.

The semiconductor memory 11 is independent for each of the CMYK colors, and can store the CMYK image data under control of the printer controller 34.

The HDD 35 is a mass storage device, and can store various kinds of data, such as a large quantity of image data, job history data, and various programs including the program relating to the present invention. The HDD 35 and the semiconductor memory 11 correspond to the image storage unit. Instead of the HDD 35, other mass storage devices such as optical disk device can be used.

The image data stored in the semiconductor memory 11 is also stored in the HDD 35 at any time. This is for avoiding the necessity of re-reading the same document when paper is jammed at the time of printing (print out) and printing does not finish normally, or for performing electronic sorting for rearranging the image data of a plurality of original documents. Recently, there is a full color multifunction product having a function of storing the image data of the read document and re-outputting (re-printing or re-distributing) the image data when necessary, in addition to these functions.

Lossy compression is performed to the CMYK image data here, but if the general purpose bus I/F 15 has a sufficiently wide band, and the storage capacity of the HDD 35 for storing the image data is large, the data may be handled without compression. This will prevent image deterioration due to the lossy compression.

At the time of copying, the CMYK image data (compressed data) in the HDD 35 is once extracted in the semiconductor memory 11 by the printer controller 34, and then transmitted to the fixed length multi-level decompressor 36 in the engine unit through the general purpose bus I/F 15.

The fixed length multi-level decompressor (fixed length lossy decompressor) 36 in the engine unit is a decompression unit, which decompresses (decodes) the image data (compressed data) transmitted from the printer controller unit. In other words, the fixed length multi-level decompressor 36 converts the 2-bit image data for each of the CMYK colors into 8-bit image data for each color. The converted image data is transmitted to the printer correction unit 37.

The printer correction unit 37 performs printer gamma processing and printer tone processing, with respect to the data of the CMYK colors transmitted from the fixed length multi-level decompressor 36, and performs correction processing for shading characteristics of the printer and levels of gray conversion processing. In the levels of gray conversion processing, conversion from 8-bit data for each of the CMYK colors to 1-bit data for each color is performed by using error diffusion and dither processing. The printer correction unit 37 transmits the processed image data to the WRITING UNIT 38 for each color.

The WRITING UNIT 38 modulates a semiconductor laser (laser diode) (not shown) based on the C image data transmitted from the printer correction unit 37, so that the corresponding laser beam is emitted and periodically deflected by a polygon mirror (rotatable polygon mirror), to form an electrostatic latent image by performing repeated scan in the horizontal scanning direction (horizontal scanning), on a drum-like or belt-like photosensitive-member (uniformly charged with electricity by a charger in the imaging unit 39 beforehand) rotating in the vertical scanning direction, by the laser beam focused by a scan lens. Likewise, the similar processing is performed with respect to the respective M, Y, and K image data sequentially transmitted from the printer correction unit 37.

The imaging unit 39 is a transfer paper printing unit, using an electro photographic process in which writing is performed by laser beam, which draws a 1-bit image data for each of the CMYK colors on the photosensitive member as an electrostatic image, and forms a copied image on the transfer paper, after the imaging and transfer processing by the CMYK toners.

For example, the photosensitive member is uniformly charged by the charger, and the C toner is adhered on the electrostatic latent image corresponding to the C image data formed on the photosensitive member by the developing unit for the C color, to form a C toner image, which is then transferred onto a belt-like or drum-like intermediate transfer body by a primary transfer unit. The M toner is then adhered on the electrostatic latent image corresponding to the M image data formed on the photosensitive member by the developing unit for the M color, to form an M toner image, which is then transferred onto the C toner image on the intermediate transfer body by the primary transfer unit.

Thereafter, similar processing is performed sequentially by the respective developing units for the Y and. K colors, to form four color toner images on the intermediate transfer body. After the four color toner images are collectively transferred onto the transfer paper fed from a paper feeder by a secondary transfer unit, the toner image on the paper is fused and fixed by a fuser unit, and the paper after fixing processing (copy) is ejected from a feeder output unit. The imaging order is not limited to CMTK.

For the engine controller 12, a microcomputer including a CPU, a ROM, and a RAM is used, which comprehensively controls the whole engine unit.

The engine unit has an auto color select (ACS) function, and when the CPU in the engine controller 12 recognizes the image data (original document) input from the read unit 31 as full color data (a full color document), or as a monochrome data (a monochrome document), based on the color determination result by the color determination unit 41, the engine unit allows image formation of respective CMYK colors, or of K color (monochrome), by the WRITING UNIT 38 and the image forming unit 8.

The facsimile controller 13 controls transfer of facsimile data (image data) between a facsimile machine or other image forming apparatus such as a full color multifunction product having the facsimile function and the full color multifunction product, via the public line.

The image format conversion unit 10 is a format conversion unit, and performs various processing such as conversion of a format of the image data (image data format).

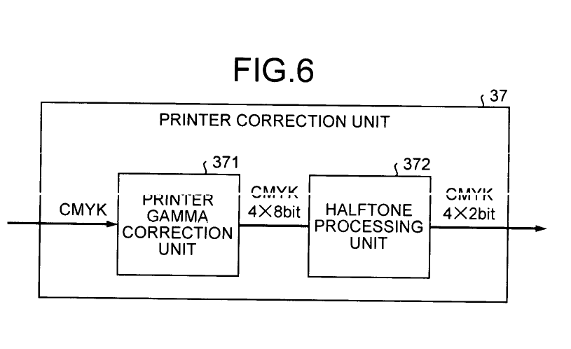

The NIC 14 is a communication unit, and communicates with an external device such as a PC 50 (external PC) on the network such as a local area network (LAN). The operation panel 20 (FIG. 6) includes various operation buttons such as a copy button (copy key), and a display for displaying a variety of information.

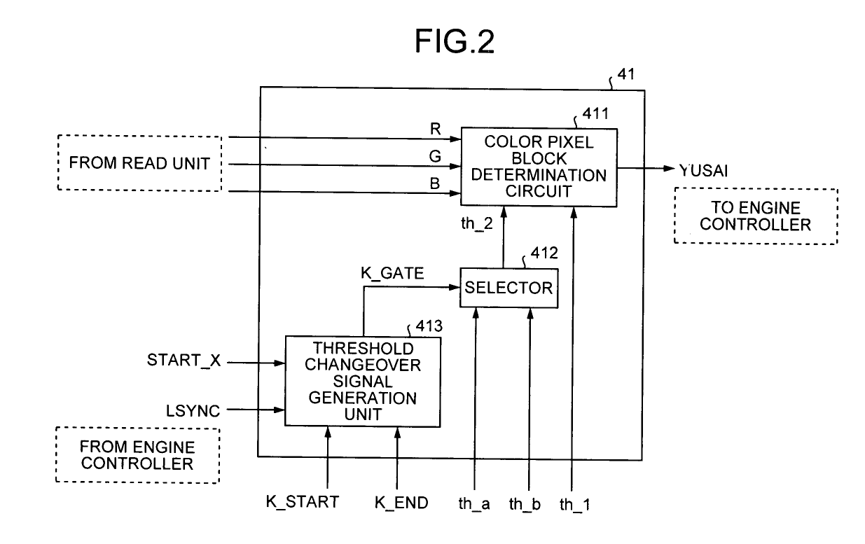

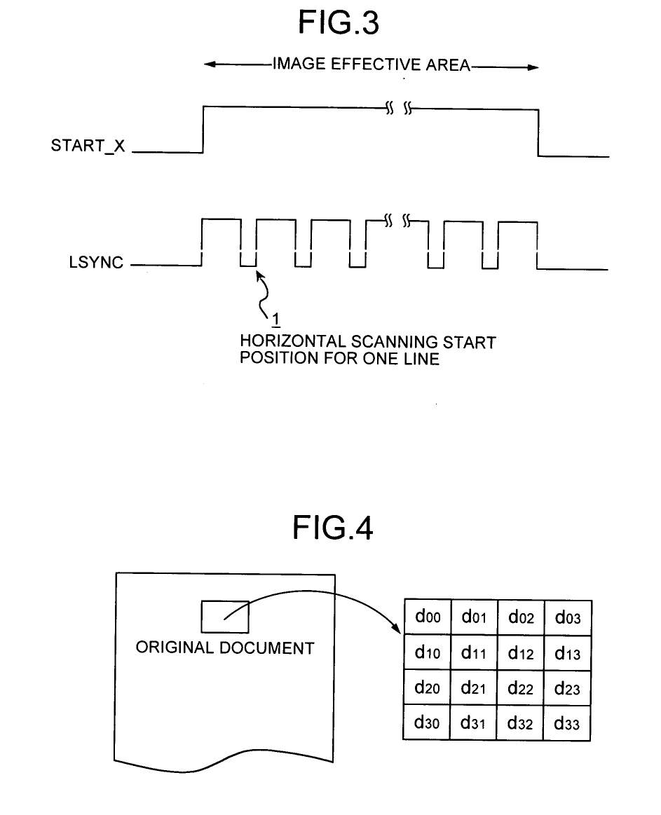

FIG. 2 is a block diagram of functional configuration of a color determination unit 41. FIG. 3 is a timing chart indicating an effective image area signal START_X and a line synchronization signal LSYNC input to the color determination Unit 41, at the time of image forming based on image data for one page.

The color determination unit 41 can correspond to a type in which the read unit 31 optically reads the image of the original document, which is passing through the read position by automatic feed of the ADF, and has a color pixel block determination circuit 411, a selector 412, and a threshold changeover signal generation unit 413.

The threshold changeover signal generation unit 413 outputs a K_GATE signal to the selector 412. The color pixel block determination circuit 411 performs the following processing based on the 8-bit image data of the respective RGB colors for each pixel of the document image transmitted from the read unit 31. In this embodiment, as shown in FIG. 4, determination is performed for each unit block (16 pixels) per unit of four lines×four pixels.

In other words, the maximum value delta RGB of a difference between RGB colors is calculated by the following equation:

ΔRGB=d[i,j]

(d[i,j]=MAX[rij,gij,bij]−MIN[rij,gij,bij] i,j=0,1,2,3)

The number of pixels in which the largest color difference d[i, j] is larger than a color difference threshold th_{—}1 in the unit block is counted. This is referred to as the number of chromatic color pixels, |C|, then, |C| is obtained from the following equation:

|C|={d[i,j]|d[i,j]>th_{—}1}

When the number of chromatic color pixels |C| is larger than a color difference threshold th 2, the color pixel block determination circuit 411 determines that the image data is a chromatic color document (full color document), and informs the engine controller 12 of the determination result. In this example, a color determination signal YUSAI to the engine controller 12 is set to a high level “H”.

On the contrary, when |C| is smaller than th 2, the color pixel block determination circuit 411 determines that the image data is an achromatic document (monochrome document), and informs the engine controller 12 of the determination result. In this example, the color determination signal YUSAI is set to a low level “L”.

The selector 412 selects either of the two thresholds th_a and th_b, corresponding to a threshold changeover signal K_GATE from the threshold changeover signal generation unit 413. That is, when the threshold changeover signal K_GATE is “H” or “L”, the selector 412 selects the threshold th_b or th_a, respectively. The selector 412 then outputs the selected threshold to the color pixel block determination circuit 411, as a color determination threshold th_{—}2. Comparing th_a and th_b, th_b is a parameter likely to be determined as being achromatic than th_a in the color determination.

The effective image area signal START_X and the line synchronization signal LSYNC are input to the threshold changeover signal generation unit 413 from the engine controller 12. For example, as shown in FIG. 3, the effective image area signal START_X indicates an effective image area in which the “H” unit is in the vertical scanning direction (rotation direction of the photosensitive member). In the line synchronization signal LSYNC, a point in time when the signal changes from “L” to “H” indicates a line start position (horizontal scanning start position for one line by a laser beam).

The threshold changeover signal generation unit 413 can control the line position in the vertical scanning direction, by counting up (+1) every time the line synchronization signal LSYNC changes from “L” to “H”, after the effective image area signal START_X changes from “L” to “H”. According to the line position, the threshold changeover signal generation unit 413 controls the output of the threshold changeover signal K_GATE.

The CPU in the engine controller 12 allows the threshold changeover signal generation unit 413 to input and set the width of the threshold changeover area, that is, the number of area start lines K_START corresponding to the area start line position, and the number of area end lines K_END corresponding to the area end line position.

The width of the threshold changeover area

=(the number of area start lines, the number of area end lines)

=(K_START, K_END).

As a result, when the effective image area signal START_X changes from “L” to “H”, the threshold changeover signal generation unit 413 counts up every time the line synchronization signal LSYNC changes from “L” to “H”, and changes the threshold changeover signal K_GATE from “L” to “H”., when the count number reaches the number of area start lines K_START, and changes the threshold changeover signal K_GATE from “H” to “L”, when the count number reaches the number of area end lines K_END.

In other words, in the period while the count number reaches from the number of area start lines K_START to the number of area end lines K_END, the threshold changeover signal generation unit 413 sets the threshold changeover signal K_GATE to “H”, and in other periods, sets it to “L”.

The width of the threshold changeover area can be set to an optional width. Further, the width of the threshold changeover area may be set in a plurality of numbers.

For example, when it is desired to set the width of the threshold changeover area at three places, by setting it to

Width of the threshold changeover area A=(1000, 1100),

Width of the threshold changeover area B=(2000, 2500),

Width of the threshold changeover area C=(3000, 3300),

a desired area can be set as the threshold changeover area.

In this example, the line position in the vertical scanning direction is controlled by counting up (+1) every time the line synchronization signal LSYNC changes from “L” to “H”. However, the line position in the vertical scanning direction may be controlled by measuring the time since the effective image area signal START_X changed from “L” to. “H”.

Further, other color determination processing may be used. This is a known technique, and for example, described in Japanese Patent Application Laid Open Publication Nos. S63-107274, 2000-152000, 2001-157051, and H6-14205.

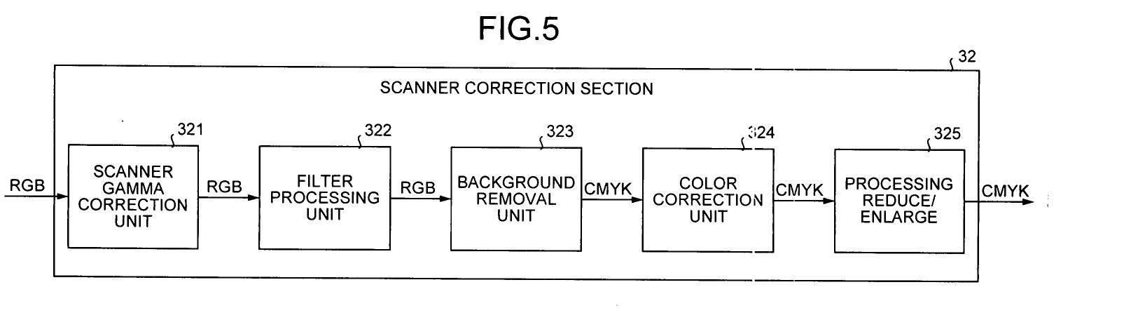

FIG. 5 is a block diagram of functional configuration of a scanner correction unit 32 shown in FIG. 1. The scanner correction unit 32 has a scanner gamma (y) correction unit 321, a filter processing unit 322, a background removal unit 323, a color correction unit 324, a reduce/enlarge processing unit 325, and a color determination unit 41 (color determination unit).

The scanner gamma correction unit 321 performs scanner gamma (y) correction processing with respect to the image data, and the filter processing unit 322 performs filter processing with respect to the corrected image data. The background removal unit 323 performs background removal processing, and the color correction unit 324 performs color correction processing (color conversion from the RGB system to the CMYK system) with respect to the image data after the background removal processing. The reduce/enlarge processing unit 325 performs reduce/enlarge processing with respect to the processed image data, and transmits the image-processed image data to the fixed length multi-level compressor (fixed length lossy compressor) 33.

The processing by the background removal unit 323 will be described in detail. The user instructs ON/OFF of the background removal processing, thereby setting whether to operate the background removal unit 323. When the user instructs ON, the (background removal) processing for removing the data at the background level is performed, and when the user instructs OFF, this processing is not performed. The setting information of ON/OFF of the background removal processing instructed here is stored in the HDD 35 in the subsequent stage, associated with the image data.

As the background removal unit used here may be any unit known as this kind of unit. For example, in a method in which the removal quantity of the background is determined by actually detecting the background level of the original document, the background level is detected by pre-scanning, in which image forming is not performed, and the removal quantity (threshold) is determined according to the detected value, to remove the background based on the determined removal quantity (threshold) by the main scanning, in which image forming is performed (the background is removed so that the output becomes zero with respect to the image data input of not larger than the threshold).

When the pre-scanning is not performed, the background removal may be performed by a method of setting the removal quantity determined beforehand as an appropriate value.

FIG. 6 is a block diagram of functional configuration of a printer correction unit 37 shown in FIG. 1. The printer correction unit 37 has a printer gamma correction unit 371 and a halftone processing unit 372. The printer gamma correction unit 371 performs printer gamma correction processing sequentially with respect to the respective CMYK color data, being image data transmitted from the fixed length multi-level decompressor 36. The halftone processing unit 372 performs halftone processing sequentially with respect to the processed respective color data, associated with the processing of the WRITING UNIT 38 and the imaging unit 39, and transmits the halftone processed image data to the WRITING UNIT 38 for each color.

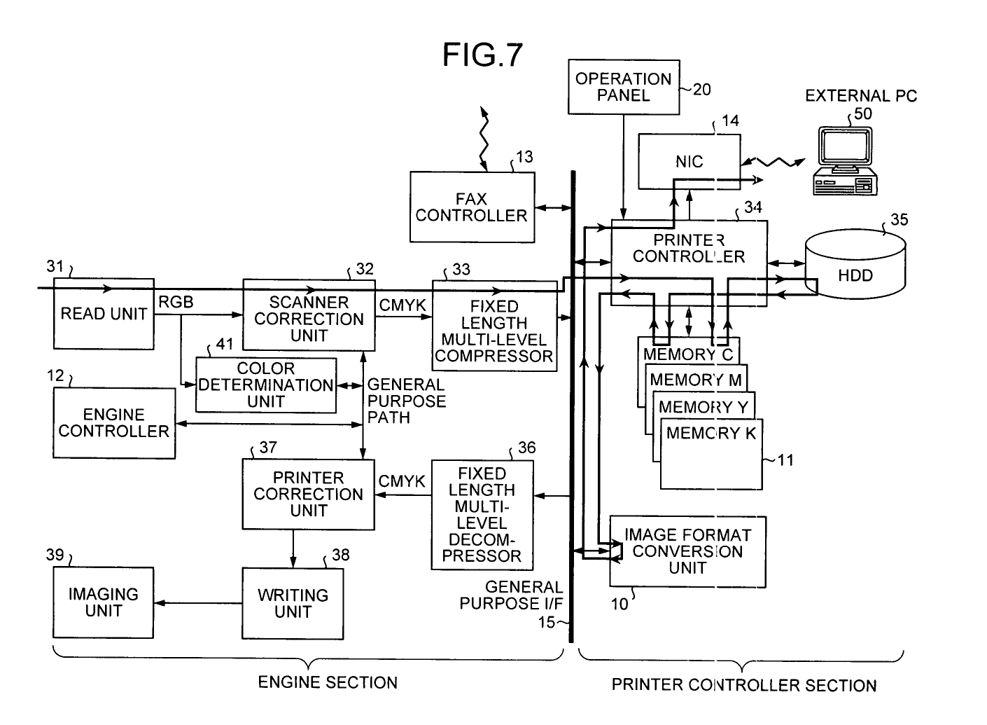

The exemplary embodiments of the portion according to the present invention in the full color multifunction product configured in this manner will be explained, with reference to the drawings from FIG. 7 to FIG. 11.

The first embodiment will be first explained. In the first embodiment, the CPU in the printer controller 34 operates in accordance with the program according to the present invention, stored (recorded) in the ROM, the HDD 35 (recording medium) or the like, thereby realizing the function as the format changeover unit and the distribution unit.

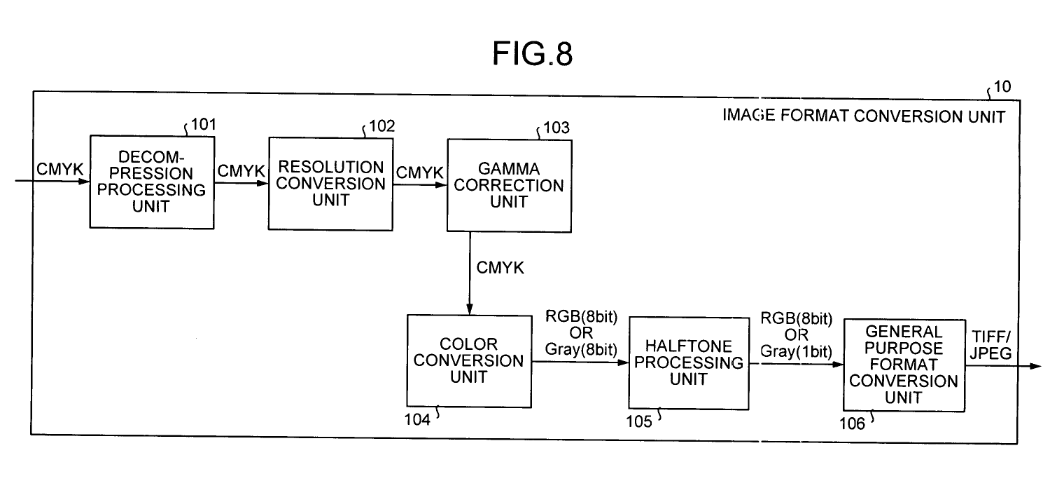

FIG. 7 is another schematic diagram of a full color multifunction product. FIG. 8 is a block diagram of an image format conversion unit 10 shown in FIG. 7. As is obvious from the comparison of FIG. 1 to FIG. 7, the flow of image data until being stored in the HDD 35 is the same as that of copying, and hence the explanation thereof is omitted.

The compressed 2-bit image data of the CMYK system having passed through the same path as that of copying is stored in the HDD 35.

When the image data is distributed to the personal computer 50 via the network, the CPU in the printer controller 34 reads out the CMYK 2-bit image data (compressed data) stored in the HDD 35, and extracts the data in the semiconductor memory 11 temporarily. The CPU then reads out the extracted image data and transmits the image data to the image format conversion unit 10 via the general purpose bus I/F 15, to allow the following processing.

FIG. 7 is a block diagram illustrating the functional configuration of the image format conversion unit 10. The image format conversion unit 10 converts the data generated at the time of using the respective functions of copy, facsimile, and printer, as the elements used for the distribution function of the stored input image data and stored in the HDD 35, into a general purpose data format, which can be easily processed by the external equipment at the destination (in this example, the external personal computer 50).

As shown in FIG. 8, the image format conversion unit 10 has a decompression processing unit 101, a resolution conversion unit 102, a gamma correction unit 103 (a gamma correction processing unit), a color conversion unit 104 (a color conversion processing unit), a halftone processing unit 105 (a halftone processing unit), and a general format conversion unit 106 (a format conversion unit), thereby performing the image format conversion processing (image processing) with respect to the image data transmitted from the printer controller 34 via the general purpose bus I/F 15.

In other words, the decompression processing unit 101 decompresses the image data (compressed data) (converts the respective CMYK 2-bit image data into respective 8-bit color data), and the resolution conversion unit 102 performs resolution conversion processing for converting the resolution of the decompressed image data to a predetermined resolution. The gamma correction unit 103 performs gamma correction processing with respect to the processed image data, and the color conversion unit 104 performs color conversion processing (color conversion from the CMYK system to the RGB system) with respect to the processed image data. The halftone processing unit 105 then performs halftone processing with respect to the color-converted image data, and the general format conversion unit 106 converts the halftone-processed image data to the general format.

The color conversion unit 104 can not only convert the image data from the CMYK system to the RGB system, but also convert to any color coordinate system (color space) such as sRGB and Y-signal, U-signal, V-signal (hereinafter, “YUV”), by the user operation (instruction) on the operation panel 20 or the personal computer 50. The user can set the resolution beforehand on the operation panel 20 or the personal computer 50.

The CPU in the printer controller 34 distributes the image data subjected to the format conversion processing by the image format conversion unit 10 to the personal computer or other general-purpose information processing units (external devices) on the network by the NIC 14.

The CPU in the printer controller 34 obtains the color determination result by the color determination unit 41 in the scanner correction unit 32 from the engine controller 12 via the general purpose bus I/F 15, and changes over the general format (predetermined format) converted by the general format conversion unit 106 in the image format conversion unit 10, corresponding to the color determination result.

The general purpose image format conversion unit 106 converts the image data subjected to the respective image processing including the halftone processing by the respective units to a format that can be used (read, edited, or processed) by a general purpose information processing unit such as the personal computer 50, being an external device. The conversion format includes, for example, a joint photographic expert group (JPEG) format, a tagged image file format (TIFF), and a bitmap (BPM) format.

For example, when the color determination unit 41 in the scanner correction unit 32 determines that the image data (original document) input from the read unit 31 is full color data (a full color document) or monochrome data (a monochrome document), general purpose image format conversion unit 106 changes over the format to the JPEG format (selects the JPEG format), or to the binary TIFF format (selects the TIFF format), respectively. The format may be changed over to any other general format, or unified to the same general format.

If this can be set by the user operation (specification) on the operation panel 20 or the personal computer 50, the format can be matched with the user's preference.

The color determination unit 41 in the scanner correction unit 32 performs the color determination processing for determining whether the image data (original document) input from the read unit 31 is full color data (a full color document) or monochrome data (a monochrome document), the CPU in the printer controller 34 changes over the general format (predetermined format) converted by the general format conversion unit 106 in the image format conversion unit 10, corresponding to the color determination result, and allows the image format conversion unit 10 to perform the image format conversion processing with respect to the image data read from the semiconductor memory 11 (image data stored in the HDD 35), and the NIC 14 distributes the processed image data to the personal computer 50 on the network. Accordingly, optimum processing becomes possible with respect to the respective original documents (image data), regardless of the determination result whether the original documents read by the read unit 31 is a full color document (full color data) or a monochrome document (monochrome data). As a result, it is not necessary to perform the condition setting separately with respect to the respective original documents, thereby improving the workability. Further, the image data read from the original documents can be directly used, that is, read, edited, or processed by the personal computer 50.

The image format conversion unit 10 may include a special format processing unit, instead of the general format conversion unit 106, so that the image data subjected to the respective image processing including the halftone processing by the respective units including the halftone processing unit 105 can be converted into a special format (predetermined format) that can be used by an external device other than the general purpose information processing unit. In this case, it is assumed that the external device has special purpose software (a special purpose program) for using the image data in the special format. Therefore, the image data read from the original documents can be directly used, that is, read, edited, or processed by an external device other than the general purpose image processing apparatus.

The image format conversion unit 10 includes the decompression processing unit 101, the resolution conversion unit 102, the gamma correction unit 103, the color conversion unit 104, and the halftone processing unit 105, in addition to the general format conversion unit 106 (or the special format processing unit), but these units other than the general format conversion unit 106 are not always necessary. In this case, the CPU in the printer controller 34 directly converts the image data read from the semiconductor memory 11 to the general format (or the special format) by the general format conversion unit 106 (or the special format processing unit) in the image format conversion unit 10, and the NIC 14 can distribute the format-converted image data to the personal computer 50 or other external devices on the network.

Alternatively, the image format conversion unit 10 may include any one or a plurality of (an optional combination of) the decompression processing unit 101, the resolution conversion unit 102, the gamma correction unit 103, the color conversion unit 104, and the halftone processing unit 105, in addition to the general format conversion unit 106 (or a special format processing unit). In this case, the CPU in the printer controller 34 can perform any or a plurality of processing of the following (1) to (5).

(1) After the image data (compressed data) read from the semiconductor memory 11 is decompressed by the decompression processing unit 101 in the image format conversion unit 10, the general format conversion unit 106 (or a special format processing unit) converts the decompressed image data to the general format (or the special format), and the NIC 14 distributes the format-converted image data to the personal computer 50 or other external devices on the network.

(2) The resolution conversion unit 102 in the image format conversion unit 10 performs resolution correction processing with respect to the image data read from the semiconductor memory 11, the general format conversion unit 106 (or a special format processing unit) converts the processed image data to the general format (or the special format), and the NIC 14 distributes the format-converted image data to the personal computer 50 or other external devices on the network.

(3) After the gamma correction unit 103 in the image format conversion unit 10 performs gamma correction processing with respect to the image data read from the semiconductor memory 11, the general format conversion unit 106 (or a special format processing unit) converts the processed image data to the general format (or the special format), and the NIC 14 distributes the format-converted image data to the personal computer 50 or other external devices on the network.

(4) After the color conversion unit 104 in the image format conversion unit 10 performs color correction processing (conversion from the CMYK system to the RGB system) with respect to the image data read from the semiconductor memory 11, the general format conversion unit 106 (or a special format processing unit) converts the processed image data to the general format (or the special format), and the NIC 14 distributes the format-converted image data to the personal computer 50 or other external devices on the network.

(5) After the halftone processing unit 105 in the image format conversion unit 10 performs halftone correction processing with respect to the image data read from the semiconductor memory 11, the general format conversion unit 106 (or a special format processing unit) converts the processed image data to the general format (or the special format), and the NIC 14 distributes the format-converted image data to the personal computer 50 or other external devices on the network.

In a second embodiment of the present invention, the CPU in the printer controller 34 operates in accordance with the program according to the present invention, stored in the ROM or in the HDD 35, thereby realizing the functions as the format changeover unit, the color conversion processing changeover unit, and the distribution unit.

In this second embodiment, a different point from the first embodiment is that the CPU in the printer controller 34 also performs the following processing.

The CPU in the printer controller 34 obtains the color determination result by the color determination unit 41 in the scanner correction unit 32 from the engine controller 12 via the general purpose bus I/F 15, and changes over the color conversion processing by the color conversion unit 104 in the image format conversion unit 10, corresponding to the color determination result. Actually, the CPU changes over the parameters used for the color conversion processing or the color conversion processing method. Changeover of the color conversion processing method stands for changeover of circuits, when the color conversion unit 104 includes a plurality of color conversion circuits in which parameters different from each other are respectively set as the parameter used for the color conversion processing.

For example, when the image data (original document) input from the read unit 31 is determined to be full color data (a full color document) by the color determination unit 41 in the scanner correction unit 32, the CPU changes over to a parameter or a method that can reproduce a copy image (an image on the copy output document) with fidelity on a display of the personal computer 50 or another external device on the network. When the image data (original document) is determined to be monochrome data (a monochrome document), the CPU changes over to a parameter or a method that decreases the chroma so that the RGB values become equal in an achromatic area. In this case, when the image data is subjected to the color conversion processing using the changed parameter or method, the image data is converted to gray-scale data.

The general format conversion unit 106 (or the special format processing unit) then converts the gray-scale image data to the general format (or the special format). The NIC 14 distributes the format-converted image data to the personal computer 50 or other external devices on the network.

Therefore, according to the second embodiment, users can obtain distributed images in a color reproduction and a color space most suitable for the respective documents.

As other examples, when the original document is determined to be a color image, the color correction unit 324 transmits the CMYK image data to the subsequent stage, in the same manner as in the normal processing, and when the original document is determined to be a monochrome image, the color correction unit 324 transmits only the K image data to the subsequent stage. As a result, appropriate processing can be performed automatically according to the color determination result.

The image data at the time of determining whether the document is a chromatic document or an achromatic document may be temporarily stored in the memory 42 without performing pre-scanning, and the stored data may be transferred to the scanner correction unit 32. According to this method of using the memory 42, pre-scanning can be omitted, thereby improving the productivity. However, since the data from the read unit 31 is directly stored in the memory 42, an increase in consuming memory cannot be avoided.

In a third embodiment of the present invention, the CPU in the printer controller 34 operates in accordance with the program according to the present invention, stored in the ROM or in the HDD 35, thereby realizing the functions as the format changeover unit, the gamma correction processing changeover unit, and the distribution unit.

In the third embodiment, a different point from the first embodiment is that the CPU in the printer controller 3.4 also performs the following processing.

The CPU in the printer controller 34 obtains the color determination result by the color determination unit 41 in the scanner correction unit 32 from the engine controller 12 via the general purpose bus I/F 15, and changes over the gamma correction processing by the gamma correction unit 103 in the image format conversion unit 10, corresponding to the color determination result. Actually, the gamma correction data used for the gamma correction processing is changed over, according to the color determination result.

For example, when the color determination unit 41 in the scanner correction unit 32 determines that the image data (original document) input from the read unit 31 is full color data (a full color document), the CPU changes over the gamma correction data so that the gamma correction unit 103 can perform smooth gamma correction processing, giving much emphasis on the tone. When the color determination unit 41 determines that the image data is monochrome data (a monochrome document), the CPU changes over the gamma correction data so that the gamma correction unit 103 can perform gamma correction processing with high contrast, giving much emphasis on the legibility of characters.

Therefore, according to the third embodiment, users can obtain distributed images having optimum gamma characteristics for the respective documents.

In a fourth embodiment of the present invention, the CPU in the printer controller 34 operates in accordance with the program according to the present invention, stored in the ROM or in the HDD 35, thereby realizing the functions as the format changeover unit, the halftone processing changeover unit, and the distribution unit.

In the fourth embodiment, a different point from the first embodiment is that the CPU in the printer controller 34 also performs the following processing.

The CPU in the printer controller 34 obtains the color determination result by the color determination unit 41 in the scanner correction unit 32 from the engine controller 12 via the general purpose bus I/F 15, and changes over the halftone processing by the halftone processing unit 105 in the image format conversion unit 10, corresponding to the color determination result. Actually, the halftone processing method is changed over.

For example, when the color determination unit 41 in the scanner correction unit 32 determines that the image data (original document) input from the read unit 31 is full color data (a full color document), the CPU changes over the halftone processing method, so that the halftone processing unit 105 can directly output the 8-bit image data (RGB data), giving much emphasis on the tone (so that the processing is not performed). When the color determination unit 41 determines that the image data is monochrome data (a monochrome document), the CPU changes over the halftone processing method, so that the halftone processing unit 105 performs binary error diffusion or dither processing with respect to the 8-bit image data, giving much emphasis on the data quantity.

Therefore, according to the fourth embodiment, users can obtain distributed images subjected to optimum halftone processing for the respective documents.

In a fifth embodiment of the present invention, the CPU in the printer controller 34 operates in accordance with the program according to the present invention, stored in the ROM or in the HDD 35, thereby realizing the functions as the format changeover unit, the halftone processing changeover unit, a halftone processing changeover inhibition unit, a halftone processing changeover inhibition selection unit, and the distribution unit.

In the fifth embodiment, a different point from the first embodiment is that the CPU in the printer controller 34 also performs the following processing.

The CPU in the printer controller 34 obtains the color determination result by the color determination unit 41 in the scanner correction unit 32 from the engine controller 12 via the general purpose bus I/F 15, and when the CPU recognizes that full color data (a full color document) and monochrome data (a monochrome document) exist together from the color determination result, the CPU inhibits changeover of the halftone processing by the halftone processing unit 105. That is, the halftone processing performed to the image data of the respective documents (in which a full color document and a monochrome document exist together) stored in the HDD 35 is unified (united in one).

For example, when the image data for five documents stored in the HDD 35 (image data input from the read unit 31) is distributed, it is assumed that the image data for one document, of the image data, is determined to be full color data, and the image data for the remaining four documents are determined to be monochrome data, by the color determination unit 41.

At this time, if the halftone processing to be applied is performed through eight bits, the respective images after having been distributed to the personal computer 50 or other external devices have a unified impression on the display (the impression of the user for the appearance can be unified), and hence the images can be easily united as one document.

The user may want to perform the halftone processing separately with respect to the image data for the respective documents, without unifying the processing. In such a case, the CPU in the printer controller 34 can select whether to inhibit the changeover of the halftone processing by the halftone processing unit 105 in the image format conversion unit 10 (ON/OFF), by a request (operation signal) generated by user's operation on the operation panel 20, the personal computer 50, or another external device.

When a full color document and a monochrome document exist together, since optimum processing is automatically performed, it is very convenient for users.

In a sixth embodiment of the present invention, the CPU in the printer controller 34 operates in accordance with the program according to the present invention, stored in the ROM or in the HDD 35, thereby realizing the functions as the format changeover unit, the format changeover inhibition unit, a format changeover inhibition selection unit, a format setting unit, and the distribution unit.

In the sixth embodiment, a different point from the first embodiment is that the CPU in the printer controller 34 also performs the following processing.

The CPU in the printer controller 34 obtains the color determination result by the color determination unit 41 in the scanner correction unit 32 from the engine controller 12 via the general purpose bus I/F 15, and when the CPU recognizes that full color data (a full color document) and monochrome data (a monochrome document) exist together from the color determination result, the CPU inhibits changeover of the format converted by the general format conversion unit 106 (or the special format unit) in the image format conversion unit 10. That is, the format of the conversion processing performed to the image data of the respective documents (in which a full color document and a monochrome document exist together) stored in the HDD 35 is unified.

For example, when the image data for five documents stored in the HDD 35 (image data input from the read unit 31) is distributed, it is assumed that the image data for one document, of the image data, is determined to be full color data, and the image data for the remaining four documents are determined to be monochrome data, by the color determination unit 41.

In this case, since the CPU in the printer controller 34 can recognize that full color data (a full color document) and monochrome data (a monochrome document) exist together by the color determination unit 41, the CPU inhibits changeover of format converted by the general format conversion unit 106 (or the special format unit) in the image format conversion unit 10, and unifies the format of the image data for the respective documents to be distributed, that is, the format of the image data for the respective documents stored in the HDD 35 to a preset format (for example, the JPEG format).

The format in this case can be set so that the CPU in the printer controller 34 can change the format, by a request generated by user's operation on the operation panel 20, the personal computer 50, or another external device.

After having unified the format, the CPU in the printer controller 34 sequentially reads the image data for the respective documents stored in the HDD 35 and extracts the image data in the semiconductor memory 11, and transmits the image data to the image format conversion unit 10 via the general purpose bus I/F 15. The image format conversion unit 10 performs the following processing.

That is, the decompression processing unit 101 decompresses the sequentially transmitted image data (compressed data) for the respective documents, the resolution conversion unit 102 performs the resolution conversion processing for converting the resolution of the decompressed image data to a preset resolution, and the gamma correction unit 103 performs the gamma correction processing with respect to the resolution-converted image data. The color conversion unit 104 then performs color conversion processing with respect to the gamma-corrected image data, the halftone processing unit 105 performs the halftone processing with respect to the color-converted image data, and the general format conversion unit 106 converts the halftone-processed image data to a preset format.

As a result, the respective image data after having been distributed to the personal computer 50 or other external devices can be easily handled as one file (document), and hence the same effect as that of the fifth embodiment can be obtained.

The user may want to use separate format with respect to the image data for the respective documents, without unifying the format. In such a case, the CPU in the printer controller 34 can select whether to inhibit the changeover of the format converted by the general format conversion unit 106 (or the special format unit) in the image format conversion unit 10 (ON/OFF), by a request generated by user's operation on the operation panel 20, the personal computer 50, or another external device.

In a seventh embodiment of the present invention, the CPU in the printer controller 34 operates in accordance with the program according to the present invention, stored in the ROM or in the HDD 35, thereby realizing the functions as the format changeover unit, the format changeover inhibition unit, the format changeover inhibition selection unit, the format setting unit, and the distribution unit.

In the seventh embodiment, a different point from the first embodiment is that the CPU in the printer controller 34 also performs the following processing.

At the time of using the distribution scanner function, it is necessary to set the processing conditions suitable for the respective documents, corresponding to the type of the document, that is, color or monochrome. The distribution scanner function has a role as a component for automating the setting. Automated setting eliminates troublesome works of operators (users), such as worrying about if it is an appropriate setting, and performing necessary changeover, and decreases the possibility that the operator makes a mistake in setting.

The color determination unit 41 determines whether the document is color or monochrome, and the CPU (not shown) having a function as a controller for the whole system sets the processing conditions relating to the distribution scanner function to optimum setting respectively, based on the determination result.

Since this function is performed as a distribution scanner function in a digital color copying machine, the resources for performing the chromatic color document determination can be shared with the copy function (see FIG. 1), thereby providing the system at a low cost.

Individual processing condition shown below from (1) to (3) automatically set upon reception of the chromatic color document determination at the time of using the distribution scanner function will be explained by way of examples.

Since the color data holds color information, the data quantity becomes considerably large, as compared with the monochrome data. Execution of color read unnecessary for the monochrome document at the time of using the distribution scanner function means transmission of meaningless information, thereby considerably decreasing the use efficiency of the data transfer time and the memory at the destination. The flow of unnecessarily large data in the network causes congestion in the network, thereby decreasing the work efficiency of not only the user of the distribution scanner function but also the whole office sharing the network. Therefore, when the document scanned at the time of using the distribution scanner function can be determined to be monochrome, the read data is converted to the monochrome data, to decrease the transmission data quantity, thereby solving such a problem.

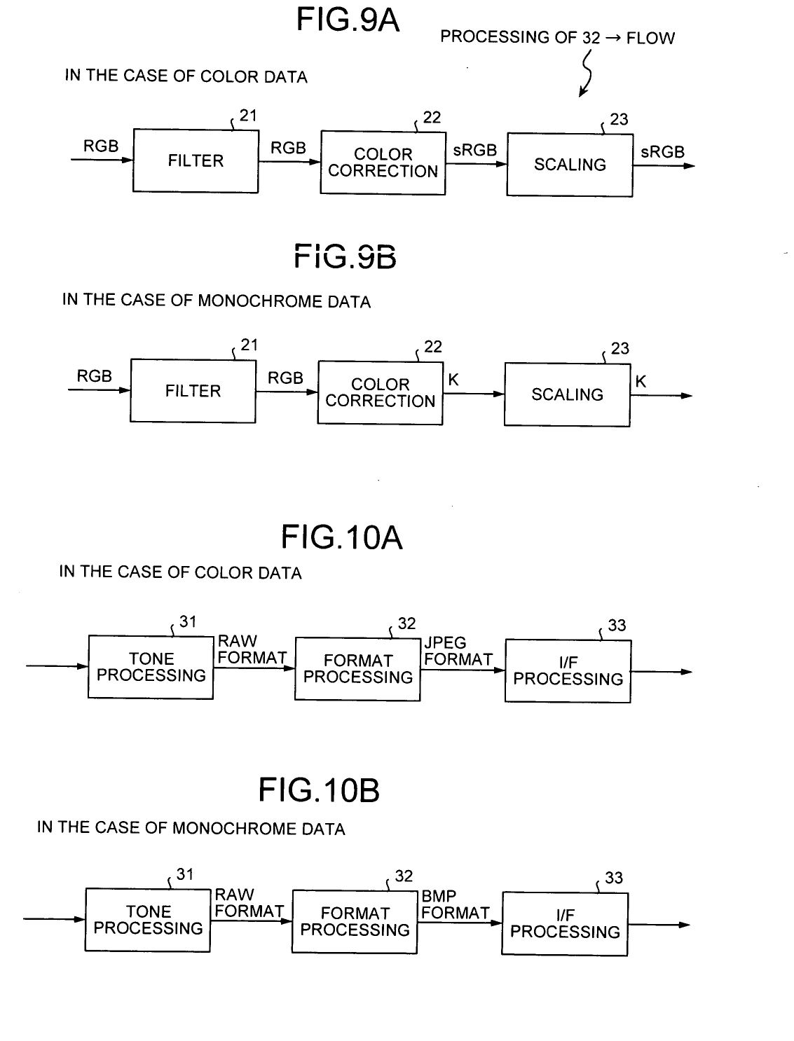

In other words, as shown in FIG. 9, in the color correction processing by the scanner correction unit 32 formed by connecting the respective circuit blocks of the filter processing unit 322, the color correction unit 324, and the reduce/enlarge processing unit 325 in order of input, when the document can be determined to be a color document (FIG. 9-1), conversion from the respective RGB 8-bit image data specific to the device (model) to the respective standard RGB (hereinafter, sRGB) 8-bit image data, being general purpose RGB (data format that can be handled at the distribution destination), is performed. When the document can be determined to be a monochrome document (FIG. 9-2), conversion from the respective RGB 8-bit image data to image data of a luminance signal K (8 bits), being a gray scale, is performed.

When color data is handled, the JPEG format, being a lossy compressed general format, is most popular from the relation between the image quality and the data quantity. On the other hand, since the monochrome data does not have a data quantity as large as that of the color data, it is generally handled in the losslessly compressed BMP format or TIFF format as it is. It is useless that the user determines whether the respective documents are color or monochrome and sets the format at the time of using the distribution scanner function, and the user may make a mistake in setting. Therefore, this problem is solved by automatically changing over the general format used at the time of using the distribution scanner function.

In other words, as shown in FIG. 10, in the format processing 32 by the image format conversion unit 10 formed by connecting the respective circuit blocks of the tone processing 31, the format processing 32, and the I/F processing 33 in order of input, when the document can be determined to be a color document (FIG. 10A), the image data is converted from RAW image data (image data whose format is not defined), which is the image data directly transferred after the scanner correction, to the general. JPEG format as scanner data of a color document. When the document can be determined to be a monochrome document (FIG. 10B), the image data is converted to the TIFF format, not to the JPEG format.

It becomes popular to handle the monochrome image data in the network in a binary image composed of one bit of monochrome data, so that the data quantity becomes as small as possible. Also in this case, it is useless that the user determines whether the document is color or monochrome for each document and sets the binarization processing when the user determines the document as a monochrome image, at the time of using the distribution scanner function, and the user may make a mistake in setting. Therefore, this problem is solved by automatically performing the binarization processing with respect to the image data, when the document is determined as a monochrome image, by using the determination result and the tone processing at the time of using the distribution scanner function.

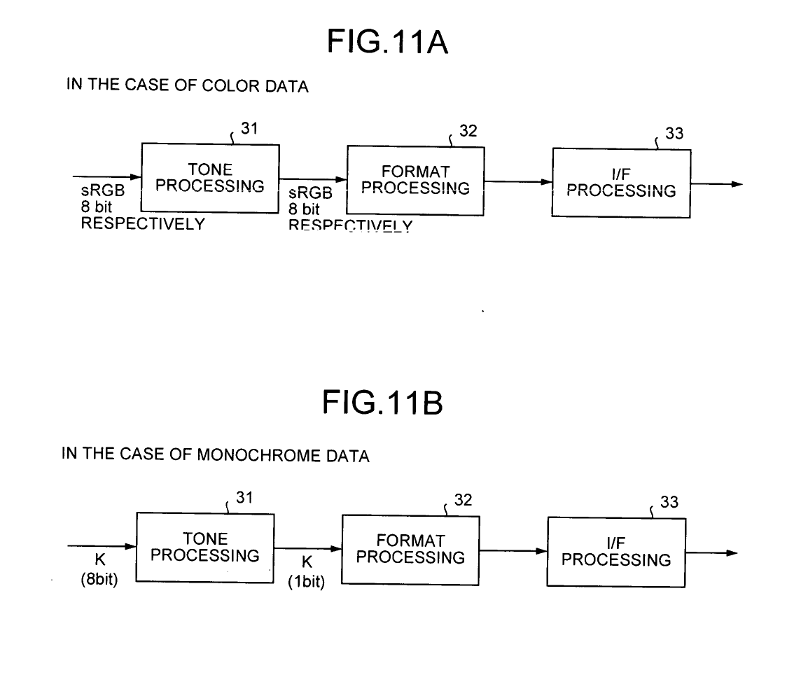

In other words, as shown in FIG. 11, in the tone processing 31 by the image format conversion unit 10 formed by connecting the respective circuit blocks of the tone processing 31, the format processing 32, and the I/F processing 33 in order of input, when the document can be determined to be a color document (FIG. 11-1), the transferred sRGB 8-bit image data is directly output without performing the tone processing. When the document can be determined to be a monochrome document (FIG. 11-2), the transferred luminance signal K (8 bits) is binarized (tone-processed) to convert to K (1 bit), and output.

In the binarization processing, the tone processing by simple threshold binarization can be applied, in which the image data of from 0 to 255 tones (8 bits) is compared with the threshold Th=128, and image data larger than the threshold is set to “1”, and image data smaller than the threshold is set to “0”.

In the digital color multifunction product according to an eighth embodiment of the present invention, as is explained when an image input by the scanner is printed and output, at the time of using the copy function, the image data is stored once in the HDD 35 as the compressed data, and when the image data is printed and output, the data stored in the HDD 35 is used. Therefore, also in the distribution function of the input image data, the stored data in the HDD 35 is used and distributed.

However, the image data stored in the HDD 35 used by the distribution function is in a special format convenient for printing processing in the apparatus. Therefore, even if the image data is directly transmitted to the external equipment (PC 50 shown in FIG. 1), the external PC 50 having received the image data may not be able to perform processing, and hence the data cannot be easily seen. Hence, the image data in the special format is converted to the general purpose image format, thereby improving the usability.

On the other hand, in the full color multifunction product in this embodiment, conversion processing suitable for each case is applied according to with or without of the background (noise) removal in the stored image data, during the conversion processing of the data format, so that appropriate data having no image deterioration, such that the background to be removed is left, or an image that should not be removed has been removed, can be generated and distributed.

The conversion processing of the data format performed according to the user's intention with respect to the scan data, of the data stored in the HDD 35, accompanied with the background removal will be explained below. It has a close connection with the copy function. Since the facsimile and printer functions do not normally involve the background removal processing, the relation with the copy function will be explained here, but if input is performed based on multi-valued data associated with the background processing, the description herein is also applicable to other functions.

In this embodiment, a unit that converts the scanned image data stored in the HDD 35 in the special format into the general format data at the time of distribution is proposed, relating to the function of distributing the scanned image (hereinafter, “scanner distribution function”). Here, conversion processing is performed corresponding to ON/OFF of the background removal in the stored image data, without deteriorating the image in the distribution data. The basic configuration of the conversion processing unit used in the respective embodiments below is shown, as a unit required for this processing.

The image data flow at the time of operating the scanner distribution function is the same as that of the conversion processing operation explained in the first embodiment with reference to FIG. 7.

2-bit CMYK compressed image data having passed through the same path as in the image data processing at the time of using the copy function, and the ON/OFF setting information of the background removal (information for setting whether to perform the background removal processing by the scanner correction unit 32, that is, ON/OFF of the operation thereof) as the control information of the image data are stored in the HDD 35.

When the image data is distributed to the external PC 50 via the network, the 2-bit CMYK compressed image data in the HDD 35 is once extracted in the semiconductor memory 11, and then transmitted to the image format conversion unit 10 via the general purpose bus 15, where conversion processing to the general format is performed corresponding to the ON/OFF of the background removal.

The functional configuration of the image format conversion unit 10 is the same as that of the image format conversion unit 10 in the first embodiment shown in FIG. 1 and explained with reference to FIG. 8. By changing over the operation of the respective conversion processing units (respective units for gamma conversion, color conversion, and halftone processing as shown in the ninth to the twelfth embodiments below) corresponding to the ON/OFF of the background removal, the image format conversion unit 10 can make the output data appropriate, but to perform the processing, it is necessary to convert the input image data to the original multi-valued data. That is, the. 2-bit CMYK compressed image data in the HDD 35 is reconverted to the 8-bit CMYK image data by the fixed length decompression processing unit 101.

The decompressed 8-bit CMYK image data is subjected to the resolution conversion processing by the resolution conversion unit 102 so as to have a resolution specified by the external PC 50, which has requested distribution, and then to the gamma processing by the gamma correction unit 103, and color conversion processing is also performed by the color conversion unit 104, so as to convert the CMYK system to another color space such as the RGB system. The converted RGB system may be any color space such as sRGB or YUV, according to the user's instruction.

When there is no instruction from the user, a color space having high generality, such as sRGB, is set. A variety of halftone processing is applied thereto by the halftone processing unit 105, after the color conversion.

The image data after the halftone processing is compressed to the general format such as JPEG, TIFF, or BMP, by the general purpose image format conversion unit 106. The converted image data is distributed to the external PC 50 via the NIC 14.

A ninth embodiment of the present invention relates to the color conversion processing in the data image format conversion unit 10. At the time of using the scanner distribution function, the image data stored in the HDD 35 in the special format is converted to the general format and distributed through the same processing as the image data processing at the time of using the copy function. When performing the conversion processing with respect to the distribution data, the data image format conversion unit 10 uses color conversion parameters suitable for the image data to be distributed, respectively, corresponding to the ON/OFF of the background removal, to perform color conversion processing so that no image deterioration occurs in the distribution data.

The color conversion processing performed here can be executed by applying a known method the method is disclosed, for example, in Japanese Patent Application Laid Open Publication No. H9-107484).

After the fixed length decompression processing unit 101 decompresses the distribution-requested compressed data in the HDD 35 to the 8-bit CMYK image data, the color conversion unit 104 in the image format conversion unit 10 performs color conversion processing from the CMYK system to the other color space such as RGB system. By checking the ON/OFF setting of the background removal controlled as information relating to the image data stored in the HDD 35 at the time of performing the color conversion processing, it is checked whether the background removal has been performed by the scanner correction unit 32 with respect to the image data of the original document at the time of reading the document by the scanner. The color conversion processing with respect to the image data stored in the HDD 35 is automatically changed over, based on this result.

When the background removal is set to OFF, if the color conversion is directly performed to distribute the image data, the data having the background and accompanied with image deterioration is output, thereby causing greasing at the time of reprinting. In this case, the conversion parameter in the color conversion unit 104 is set such that the background can be removed by color conversion.

On the contrary, when the background removal is set to ON, since the background has been already removed by the correction processing with respect to the scanned image, color conversion can be performed without worrying about the background. That is, at this time, the conversion parameter in the color conversion unit 104 can be changed to the normal setting, without taking background removal into consideration.

The image data converted to the other color space, such as the RGB system is further converted to the general format by the general purpose image format conversion unit 106, and distributed. As a result, the user can obtain a distribution image output in the optimum state from the image in which the respective ON/OFF modes of background removal are set.

A tenth embodiment of the present invention relates to gamma conversion processing in the data image format conversion unit 10. In the scanner distribution, the image data stored in the HDD 35 in the special format convenient for the copy function is converted to the general format and distributed. When performing the conversion processing with respect to the distribution data, the data image format conversion unit 10 performs gamma conversion processing suitable for the image data to be distributed, corresponding to the ON/OFF setting of the background removal, so that image deterioration does not occur in the distribution data.

The gamma conversion performed here is performed by applying a known method in which setting of the processing condition is changed over according to whether the image type is a character or a photograph, to perform gamma conversion suitable for the respective types. For example, in the image area of character portions, correction is performed by using substantially S-shape gamma curve, to emphasize black, thereby obtaining high resolution. In the image area of photograph portion, high quality can be maintained over the whole image, by using a liner gamma curve, while keeping high tone.

In the gamma correction unit 103 in the data image format conversion unit 10, the distribution-requested compressed data in the HDD 35 is decompressed to the 8-bit CMYK image data by the fixed length decompression processing unit 101, and this data is subjected to the gamma correction processing. By checking the ON/OFF setting of the background removal controlled as information relating to the image data stored in the HDD 35 at the time of performing the gamma conversion processing, it is checked whether the background removal has been performed by the scanner correction unit 32 with respect to the image data of the original document at the time of reading the document by the scanner. The gamma conversion processing with respect to the image data stored in the HDD 35 is automatically changed over, based on this result.

When the background removal is set to OFF, if the gamma conversion is directly performed to distribute the image data, the data having the background and accompanied with image deterioration is output, thereby causing greasing at the time of reprinting. In this case, the gamma curve in the gamma correction unit 103 is set such that background removal becomes possible.

On the contrary, when the background removal is set to ON, since the background has been already removed by the correction processing with respect to the scanned image, the gamma curve in the gamma correction unit 103 is set to the normal setting, without taking background removal into consideration.

The gamma-converted image data is further converted to the general format by the general purpose image format conversion unit 106 and distributed. As a result, the user can obtain a distribution image output in the optimum state from the image in which the respective ON/OFF modes of background removal are set.

An eleventh embodiment of the present invention relates to the halftone processing in the data image format conversion unit 10. In the scanner distribution, the image data stored in the HDD 35 in the special format convenient for the copy function is converted to the general format and distributed. When performing the conversion processing with respect to the distribution data, the data image format conversion unit 10 performs halftone processing suitable for the image data to be distributed, corresponding to the ON/OFF setting of the background removal, so that image deterioration does not occur in the distribution data.

The halftone processing performed here is for decreasing the information quantity at the time of distribution by decreasing the tone, and facilitating the processing at the destination, and a known method such as error diffusion processing, dither processing, or simple binarization processing is applied thereto. In this embodiment, these various kinds of halftone processing can be changed over and used.

In the halftone processing unit 105 in the data image format conversion unit 10, the distribution-requested compressed data in the HDD 35 is decompressed to the 8-bit CMYK image data by the fixed length decompression processing unit 101, and the 8-bit CMYK image data is converted to the 8-bit RGB image data or 8-bit Gray image data by the color conversion unit 104, and the halftone processing is performed with respect to this data.

By checking the ON/OFF setting of the background removal controlled as information relating to the image data stored in the HDD 35 at the time of performing the halftone processing, it is checked whether the background removal has been performed by the scanner correction unit 32 with respect to the image data of the original document at the time of reading the document by the scanner. The halftone processing with respect to the image data stored in the HDD 35 is automatically changed over, based on this result.

When the background removal is set to OFF, if the error diffusion processing is performed to distribute the image data, a texture in the highlight portion peculiar to the error diffusion processing may be generated, thereby causing deterioration in the image quality. In this case, generation of texture is suppressed by using the dither processing for the halftone processing. If the dither processing is used, however, the reproducibility of characters deteriorates, as compared with the error diffusion processing.

On the contrary, when the background removal is set to ON, since the background has been already removed by the correction processing with respect to the scanned image, the halftone processing can be performed, without worrying about the background. In other words, preferable halftone processing can be performed, such as error diffusion processing or dither processing. In the case of the simple binarization processing, the threshold at the time of binarization is changed over depending on ON/OFF of the background removal, thereby realizing optimization.

The halftone-processed image data is further converted to the general format by the general purpose image format conversion unit 106 and distributed. As a result, the user can obtain a distribution image output in the optimum state from the image in which the respective ON/OFF modes of background removal is set.

A twelfth embodiment of the present invention is for solving a problem, which occurs when ON and OFF of the background removal processing applied to the image data stored in the HDD 35, which is to be distributed, exist together, in the eleventh embodiment in which the halftone processing suitable for the respective cases of ON/OFF of the background removal is performed.

In the case of image data in which ON and OFF of the background removal exist together, the image format conversion unit 10 has to change over the applied halftone processing every time the setting of ON/OFF of the background removal changes, and hence the processing becomes complicated, causing deterioration in the processing efficiency. Further, in addition to the same problem occurring at the destination, a sense of incompatibility is generated in the image due to the difference of processing, at the time of using the distribution data (for example, there is a difference in the image displayed on a display due to the applied halftone processing).

Therefore, in this embodiment, when a plurality of images stored in the HDD 35 is distributed, and when ON and OFF of the background removal processing exist together in the stored image data, this problem is solved by unifying the halftone processing applied to the distributed image.

For example, when five stored images are to be distributed, it is assumed that the background removal is set to ON in only one image, and OFF in the remaining four images. In this case, in the fourth embodiment, application of the error diffusion processing with respect to the ON setting of the background removal, and the dither processing with respect to the OFF setting thereof can be considered. However, in this embodiment, the halftone processing applied at this time is fixed to the error diffusion processing. As a result, when the images are displayed on the display at the time of use by the external PC 50 at the destination, the impression with respect to the five images can be unified.

As the fixed processing method, the dither processing or the simple binarization processing may be used, and it is desired that the user can select and set the preferable method. Further, the user may want to set the method separately, without unifying the method. Therefore, it: is desired to give an option for enabling free setting with respect to each image.

All or a part of the first to the twelfth embodiments may be combined optionally. The color determination unit 41 and the image format conversion unit 10 are respectively special purpose hardware, for enabling high-speed processing. However, to increase the generality, the functions of the respective units in the color determination unit 41 and the image format conversion unit 10 may be formed of a programmable processor. Alternatively, the functions of the respective units in the color determination unit 41 and the image format conversion unit 10 may be realized by allowing the CPU in the printer controller 34 or a CPU provided separately to execute a predetermined program.

In this case, the programs according to the present invention (programs for realizing functions of the respective units in the color determination unit 41 and the image format conversion unit 10, and a program for realizing the distribution function) can be recorded (stored) in the ROM provided in the printer controller 34 or in the HDD 35, or may be recorded in a memory such as another ROM, being a recording medium, and provided.

The programs may be recorded in other nonvolatile recording media (memories), such as an SRAM, an EEPROM, a memory card, and an optical disk (CD-ROM etc.), and provided.

In this case, if a recording medium reader (optical disk device or the like) having a unit for inserting the nonvolatile recording medium is provided in the full color multifunction product, or externally attached thereto, the nonvolatile recording medium is inserted into the recording medium reader to read the program recorded in the nonvolatile recording: medium, and the program is installed in the HDD 35, thereby realizing the function according to the present invention. If the memory for storing the programs according to the present invention is a rewritable nonvolatile storage unit, update of the programs corresponding to the development of technology becomes easy.

Further, the programs may be downloaded from an external device connected to a network connected to the NIC 14 and having a recording medium in which the programs according to the present invention are recorded, and executed.

Exemplary embodiments in which the present invention is applied to an image processing apparatus used in the full color multifunction product have been explained, but the present invention is not limited thereto, and also applicable to image processing apparatuses used in the full color image forming apparatus such as a full color copying machine and a full color facsimile machine, and the full color scanner.

The image processing apparatus, the image processing method, the image processing program, and the recording medium according to the present invention are useful for devices that processes image data and transmits the processed image data to the outside, and particularly suitable for image processing apparatuses that perform different image processing for each image data.

The present document incorporates by reference the entire contents of Japanese priority documents, 2002-269604 filed in Japan on Sep. 17, 2002, 2002-276439 filed in Japan on Sep. 24, 2002 and 2002-322019 filed in Japan on Nov. 6, 2002.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image processing apparatus comprising:
a content determination unit that determines content of image processing to be applied to each of a plurality of image data;
an image processing unit that applies the image processing based on the content determined to corresponding image data; and
a transmission unit that transmits the image data processed to an external unit.

2. The image processing apparatus according to claim 1, further comprising a color determination unit that determines whether the image data is color image data or monochrome image data, wherein
the content determination unit determines the content, based on a result of determination by the color determination unit.

3. The image processing apparatus according to claim. 1, further comprising a scanner unit that reads out the image data from a recording medium, wherein
the content determination unit, the image processing unit, and the transmission unit operate independently of the scanner unit, in separate operation modes, respectively.

4. The image processing apparatus according to claim 2, wherein
when the color determination unit determines that the image data is color image data, the content determination unit determines the content to be conversion of the color image data into monochrome image data.

5. The image processing apparatus according to claim 2, wherein when the color determination unit determines that the image data is monochrome image data, the content determination unit determines the content to be binarization of the image data.

6. The image processing apparatus according to claim 2, wherein
the image processing includes compression processing, and
the content determination unit determines content of the compression processing based on the result of the determination by the color determination unit.

7. The image processing apparatus according to claim 1, wherein
the image processing includes general format conversion to convert the image data into image data that is available in a general information processing apparatus.

8. The image processing apparatus according to claim 1, wherein
the image processing includes color conversion processing, and
the content determination unit determines to perform the color conversion processing based on the result of the determination by the color determination unit.

9. The image processing apparatus according to claim 8, wherein the content determination unit changes a parameter for the color conversion processing for each image data.

10. The image processing apparatus according to claim 1, wherein the image processing includes gamma correction processing.

11. The image processing apparatus according to claim 10, wherein the content determination unit changes gamma correction data used for the gamma correction processing for each image data.

12. The image processing apparatus according to claim 1, wherein the image processing includes halftone processing.

13. The image processing apparatus according to claim 1, further comprising a correlation detecting unit that detects whether there is a correlation between a plurality of image data,
wherein the content determination unit determines to apply same image processing to the plurality of image data upon the correlation detecting unit detecting that there is the correlation.

14. The image processing apparatus according to claim 13, further comprising an instruction reception unit that receives an instruction, which indicates execution of the same image processing to the plurality of image data, from a user,
wherein the content determination unit determines to apply the same image processing to the plurality of image data upon the instruction reception unit receiving the instruction.

15. The image processing apparatus according to claim 1, further comprising an instruction reception unit that receives instruction, information indicating an instruction from a user, wherein
the content determination unit determines the content of the image processing, based on the instruction information for each image data.

16. The image processing apparatus according to claim 15, wherein
the image processing includes background removal processing and color space conversion,
the instruction reception unit receives the instruction information on the background removal processing for the image data, and
the content determination unit changes a parameter for the color space conversion based on the instruction information.

17. The image processing apparatus according to claim 15, wherein
the image processing further includes gamma correction,
the instruction reception unit receives the instruction information on the background removal processing for the image data, and
the content determination unit changes input/output characteristic curve for the gamma correction based on the instruction information.

18. The image processing apparatus according to claim 15, wherein
the image processing further includes halftone processing,
the instruction reception unit receives the instruction information on the background removal processing for the image data, and
the content determination unit changes the content of the halftone processing based on the instruction information.

19. The image processing apparatus according to claim 15, further comprising a correlation detecting unit that detects whether there is a correlation between a plurality of image data,
wherein the content determination unit determines to apply same image processing to the plurality of image data upon the instruction reception unit receiving different instruction information for each image data, and upon the correlation detecting unit detecting that there is the correlation.

20. The image processing apparatus according to claim 1, further comprising an image forming unit that forms an image on a recording medium based on the image data after the image processing.

21. A method for image processing comprising:
determining content of image processing to be applied to each of a plurality of image data;
applying the image processing based on the content determined to corresponding image data; and
transmitting the image data processed to an external unit.

22. A computer program making a computer execute:
determining content of image processing to be applied to each of a plurality of image data;
applying the image processing based on the content determined to corresponding image data; and
transmitting the image data processed to an external unit.

23. A computer readable recording medium that contains a computer program, the computer program making a computer execute:
determining content of image processing to be applied to each of a plurality of image data;
applying the image processing based on the content determined to corresponding image data; and
transmitting the image data processed to an external unit.
